(19) United States
(12) Patent Application Publication
(10) Pub. No.: US 2023/0360159 A1
(43) Pub. Date: Nov. 9, 2023

(54) SECURITY KNOWLEDGE LEVEL TEST METHODS AND APPARATUSES

(71) Applicant: ALIPAY (HANGZHOU) INFORMATION TECHNOLOGY CO., LTD., Hangzhou (CN)

(72) Inventor: Shan Leng, Hangzhou (CN)

(73) Assignee: ALIPAY (HANGZHOU) INFORMATION TECHNOLOGY CO., LTD., Hangzhou (CN)

(21) Appl. No.: 18/313,113

(22) Filed: May 5, 2023

(30) Foreign Application Priority Data
May 6, 2022 (CN) 202210489684.0

(51) Int. Cl. G06Q 50/20; G09B 7/00

(52) U.S. Cl. CPC G06Q 50/205; G09B 7/00

(57) ABSTRACT

Implementations of the present specification disclose methods, apparatuses, and devices for performing security knowledge level tests. In one aspect, the method includes: receiving a security knowledge test request; determining a target security regulatory authority to perform a security knowledge level test for the target user; obtaining a target security knowledge test requirement information set that corresponds to the target security regulatory authority, wherein the target security knowledge test requirement information set comprises a mapping relationship between user features and security knowledge test questions; determining corresponding test questions based on the one or more target features of the target user; providing the corresponding test questions for presentation on a client device to the target user; and determining a security knowledge level test result from inputs to the client device by the target user in response to viewing the corresponding test questions.

### CROSS-REFERENCE TO RELATED APPLICATIONS

This application claims priority to Chinese Patent Application No. 202210489684.0, filed on May 6, 2022, which is hereby incorporated by reference in its entirety.

### TECHNICAL FIELD

Embodiments of this specification relate to the field of computer application technologies, and in particular, to security knowledge level test methods and apparatuses.

### BACKGROUND

With popularization of the Internet and smartphones, new risk forms emerge continuously, and various types of security risks may exist around a user, for example, phishing text messages, an advertisement web page, or a two-dimensional code fraud. Users with a relatively low security knowledge level may be vulnerable to having their property and assets compromised due to insufficient precautions.

To help determine a security knowledge level of the user, a related department usually prepares a related activity offline. For example, a security knowledge-related test is arranged offline, or a questionnaire survey is carried out in a scenario in which a security risk or a property infringement easily occurs offline. Specifically, a questionnaire survey can be carried out in a cafe, a bar, and a bank.

However, such a manner of determining the security knowledge level offline has relatively low efficiency.

### SUMMARY

To alleviate the above-mentioned problems, embodiments of this specification provide security knowledge level test methods and apparatuses. Technical solutions are as follows:

A security knowledge level test method is provided, and is applied to a knowledge test platform. The knowledge test platform is associated with one or more security regulatory authorities, and pre-configures a corresponding security knowledge test requirement information set for each of the one or more associated security regulatory authorities. The requirement information set includes a mapping relationship between one or more user features and security knowledge test questions. The method includes: receiving a security knowledge test request, where the request includes one or more features of a target user; determining a target security regulatory authority based on the request, where the target security regulatory authority performs a security knowledge level test for the target user; determining, from a requirement information set corresponding to the target security regulatory authority, corresponding test questions based on the one or more features of the target user; and providing the determined test questions for the target user, and determining a security knowledge level test result.

A security knowledge level test apparatus is provided, and is applied to a knowledge test platform. The knowledge test platform is associated with one or more security regulatory authorities, and pre-configures a corresponding security knowledge test requirement information set for each of the one or more associated security regulatory authorities. The requirement information set includes a mapping relationship between one or more user features and security knowledge test questions. The apparatus includes: a receiving unit, configured to receive a security knowledge test request, where the request includes one or more features of a target user; a determining unit, configured to: determine a target security regulatory authority based on the request, where the target security regulatory authority performs a security knowledge level test for the target user; and determine, from a requirement information set corresponding to the target security regulatory authority, corresponding test questions based on the one or more features of the target user; and a test unit, configured to: provide the determined test questions for the target user, and determine a security knowledge level test result.

According to the above-mentioned technical solutions, the security knowledge level test is performed online, to improve efficiency of determining the security knowledge level of the user.

### BRIEF DESCRIPTION OF DRAWINGS

To describe the technical solutions in the embodiments of this specification or in the existing technology more clearly, the following briefly describes the accompanying drawings needed for describing the embodiments or the existing technology. Clearly, the accompanying drawings in the following descriptions merely show some embodiments of this specification, and a person of ordinary skill in the art can still derive other drawings from these accompanying drawings.

FIG. 1 is a schematic flowchart illustrating a security knowledge level test method, according to one or more embodiments of this specification;

FIG. 2 is a schematic structural diagram illustrating a security knowledge level test apparatus, according to one or more embodiments of this specification; and

FIG. 3 is a schematic structural diagram illustrating a device for configuring a method, according to one or more embodiments of this specification.

### DESCRIPTION OF EMBODIMENTS

To make a person skilled in the art better understand the technical solutions in the embodiments of this specification, the following describes in detail the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiments of this specification shall fall within the disclosed scope.

With popularization of the Internet and smartphones, new risk forms emerge continuously, and various types of security risks may exist around a user, for example, phishing text messages, an advertisement web page, or a two-dimensional code fraud. Users with a relatively low security knowledge level may be vulnerable to having their property and assets compromised due to insufficient precautions.

Security knowledge can specifically include security risk-related knowledge, for example, the characteristics of phishing text messages, the number patterns of scam phone calls, and differences between a trusted secure web page and a fake web page.

Users with a higher security knowledge level possess more knowledge related to security risks, making it easier for them to identify and prevent security risks around them, thereby reducing the possibility of their own property and assets being compromised.

On the contrary, users with a lower security knowledge level possess less knowledge related to security risks, making it difficult for them to identify or prevent security risk events (such as online scams) and leaving their property and assets vulnerable to being compromised.

To ensure property security of a user, a security knowledge level of the user usually needs to be first determined, so that science popularization or education can be performed on the users with a relatively low security knowledge level, to improve the security knowledge level.

To help determine the security knowledge level of the user, a related department usually prepares a related activity offline. For example, a security knowledge-related test is arranged offline, or a questionnaire survey is carried out in a scenario in which a security risk or a property infringement easily occurs offline. Specifically, a questionnaire survey can be carried out in a cafe, a bar, and a bank.

However, such a manner of determining the security knowledge level offline has relatively low efficiency and relatively high labor costs.

To alleviate the above-mentioned problems, embodiments of this specification provide a security knowledge level test method.

In this method, a security knowledge level test is performed for a user online. Specifically, a security knowledge-related test question can be published for the user online, the user answers the security knowledge-related test question, and a current security knowledge level of the user is determined based on a test result.

The security knowledge-related test question can be specifically a test question including security knowledge, so that the current security knowledge level of the user can be determined based on an answer of the user to the test question.

For example, 10 security knowledge-related test questions are published for the user online to perform a test, and it is determined, based on an answer result that all the 10 test questions are answered correctly, that the security knowledge level of the user is relatively high.

By performing an online test, efficiency of determining the security knowledge level of the user can be improved, and labor costs can be reduced.

In addition, an answer to the test question or security knowledge related to the test question can be provided, to perform the test repeatedly, until the user has a correct answer in the test, so that the user learns of the security knowledge included in the question, to improve the security knowledge level.

For example, in the first test, the user gives wrong answers to a related question because the user does not learn of phishing text messages. After learning of related knowledge, the user can determine a correct answer to the related question of the phishing text messages in the second test, to improve the security knowledge level of the user.

By performing a test by using a question, a process of determining the security knowledge level of the user can become more interesting and challenging, and an interest of the user in learning of the security knowledge can be more easily stimulated, to help improve the security knowledge level of the user.

Online testing can also facilitate the collection of user test results, making it easy to determine the overall security knowledge level among users and to identify those with lower security knowledge levels. This can be done in order to help those users improve their security knowledge through various means.

To perform a security knowledge level test for the user, a security knowledge-related test question set usually needs to be deployed.

Optionally, to adapt to different situations of different users, the different users can learn of security knowledge that is more applicable to respective situations, and different questions can be determined based on the situations of the different users to perform a test.

For example, for users aged between 50 and 80 who have less exposure to the internet, test questions related to scam phone calls or phishing text messages can be used. For users who are students and have more exposure to the internet but less social experience, test questions related to phishing web pages can be used.

Specifically, the corresponding test questions can be determined based on the user's characteristics. User features can include age, gender, occupation, behavioral traits, risk tolerance, personality traits, etc.

Therefore, during the deployment of test questions, test questions can be deployed according to the user's characteristics, making it easier to tailor the security knowledge level test to the user's actual situation and increase the accuracy of determining the user's security knowledge level.

It is worthwhile to note that, because the security knowledge level test is performed for the user online in the method, a specific development capability and a specific network operation capability are needed. However, a related department usually can hardly perform the security knowledge level test for the user online, and it is also difficult to deploy a server, so that the user takes an online test.

In addition, different related departments usually have different security knowledge level test requirements. Specifically, different related departments may want to mainly test different security knowledge, and may also need to obtain different user features.

For example, there is a large quantity of text message phishing cases in a first city. Therefore, when a related department of the first city determines a security knowledge level test question, security knowledge of the user about phishing text messages needs to be mainly tested. Specifically, a feature of a text message interaction amount of the user can be obtained, and a corresponding test question can be determined to perform a test, so as to improve consciousness of preventing the phishing text messages. However, in a second city, there is a relatively small quantity of text message phishing cases, but there is an high quantity of web page phishing cases. Therefore, when a related department of the second city determines a security knowledge level test question, security knowledge of the user about web page phishing needs to be mainly tested. Specifically, a web page browsing frequency of the user can be obtained, and a corresponding test question can be determined to perform a test, so as to improve consciousness of preventing the web page phishing.

Therefore, in the method, a unified service platform can be deployed for different related departments, to help configure corresponding security knowledge test requirement information for the different related departments based on requirements of the different related departments. Specifically, a user feature, a test question, and a mapping relationship between one or more user features and test questions can be configured based on a requirement of a related department.

The service platform can further perform an online test for the user online, and return an obtained test result to the related department, so that the related department determines the security knowledge level of the user.

By using the unified service platform, to satisfy requirements of different related departments, security knowledge test requirement information that satisfies the requirements can be configured, and a network operation capability can be provided, so that the user can take an online test, to improve efficiency of determining the security knowledge level.

The service platform can be a risk service platform for carrying out a risk-related service, for example, a service with a specific risk such as a payment service, a social service, a lending and borrowing service, a risk evaluation service, or a fund purchase service.

In a specific example, the risk service platform can be a payment application, a social application, or a financial application, and further additionally cooperates with a related department, to provide a service of testing the security knowledge level of the user. An obtained test result can reflect the security knowledge level of the user, and can further help the risk service platform to better evaluate a security risk of the user, to adjust a risk-related service of the risk service platform.

In the method, the security knowledge level test is performed online, to improve efficiency of determining the security knowledge level of the user, reduce labor costs, and accurately determine the current security knowledge level of the user based on the test result.

In addition, an answer to the question or security knowledge related to the question can be provided, to perform the test repeatedly, until the user has a correct answer in the test, so that the user learns of the security knowledge included in the question, to improve the security knowledge level.

In addition, the unified service platform can be further deployed, to help the related department determines the security knowledge test requirement information in a customized manner based on a requirement of the related department, so as to adapt to actual situations of different related departments.

A security knowledge level test method provided in one or more embodiments of this specification is explained in detail below with reference to the accompanying drawings.

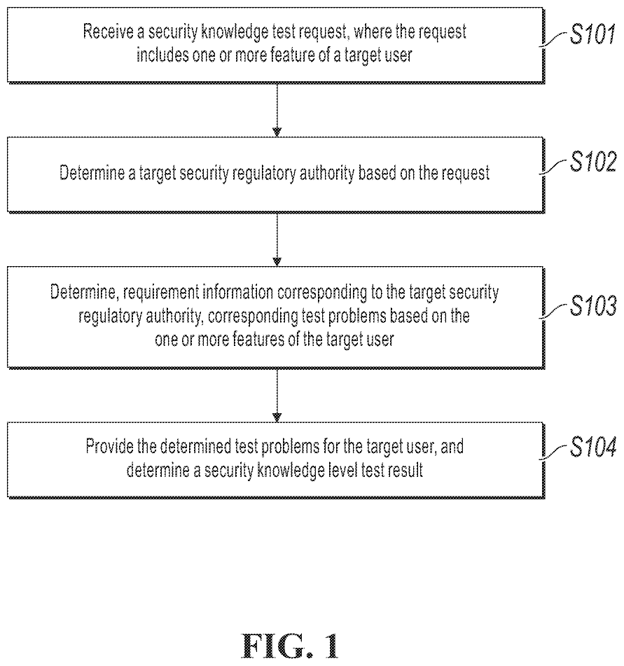

FIG. 1 is a schematic flowchart illustrating a security knowledge level test method, according to one or more embodiments of this specification.

The method can be applied to a knowledge test platform, and the knowledge test platform can be associated with one or more security regulatory authorities.

The knowledge test platform can pre-configure a corresponding security knowledge test requirement information set for each of the one or more associated security regulatory authorities. Requirement information can include a mapping relationship between one or more user features and security knowledge test questions.

For ease of description, an individual user in a procedure of the method is referred to as a target user. The target user can be any user.

The method can include the following steps:

S101: Receive a security knowledge test request, where the request includes one or more features of the target user.

S102: Determine a target security regulatory authority based on the request.

The target security regulatory authority can perform a security knowledge level test for the target user.

S103: Determine, from requirement information corresponding to the target security regulatory authority, corresponding test questions based on the one or more features of the target user.

S104: Provide the determined test questions for the target user, and determine a security knowledge level test result.

Optionally, the providing the test question for the target user can specifically include: sending the test question to the target user, so that the target user answers the received test question and completes the security knowledge level test, to help the knowledge test platform determine the security knowledge level test result of the target user.

In the procedure of the above-mentioned method, the security knowledge level test is performed online, to improve efficiency of determining a security knowledge level of the user, reduce labor costs, and accurately determine a current security knowledge level of the user based on the test result.

Customized security knowledge test requirement information can be further configured for the security regulatory authority by using the knowledge test platform, to satisfy actual requirements of different security regulatory authorities. The knowledge test platform can further help different security regulatory authorities to implement an online security knowledge level test without repeated development, to improve development efficiency.

A corresponding test question can be further determined based on the user feature, to adapt to an actual situation of the user, and improve accuracy of the security knowledge level test result.

In an optional embodiment, the knowledge test platform can pre-configure the corresponding security knowledge test requirement information set for each of the one or more associated security regulatory authorities.

The requirement information set can include the mapping relationship between one or more user features and security knowledge test questions.

For the requirement information set, different security regulatory authorities may have different actual requirements. For example, some security regulatory authorities want to be configured with a large amount of requirement information by performing a simple operation, some security regulatory authorities want to customize requirement information, and some security regulatory authorities want to add related requirement information for a certain aspect of security knowledge.

To adapt to the requirements of the different security regulatory authorities, the knowledge test platform can provide a plurality of different ways to configure the requirement information.

Optionally, the knowledge test platform can automatically configure common requirement information for the associated security regulatory authority, and the common requirement information is used as security knowledge test requirement information configured for the security regulatory authority, and can be specifically added to the security knowledge test requirement information set configured for the security regulatory authority.

The common requirement information can be obtained through service provision, making it convenient for security regulatory authorities to configure requirement information without any additional operation.

Optionally, the knowledge test platform can directly obtain customized requirement information from the security regulatory authority, and the obtained customized information is used as security knowledge test requirement information configured for the security regulatory authority, and can be specifically added to the security knowledge test requirement information set configured for the security regulatory authority.

The security regulatory authority can customize the user feature, the test question, and the mapping relationship between one or more user features and test questions.

Optionally, the knowledge test platform can provide or present optional requirement information to the security regulatory authority, to help configure the requirement information for the security regulatory authority by performing a simple selection operation, and improve configuration efficiency.

If requirement information in a certain aspect needs to be added for the security regulatory authority, a selection quantity of the related requirement information can be increased, or the related requirement information can be customized and sent to the knowledge test platform.

Because the requirement information set can include three pieces of content: the user feature, the test question, and the mapping relationship between one or more user features and test questions, the knowledge test platform can provide or present an option at a finer granularity to the security regulatory authority. Specifically, an optional user feature or an optional test question can be provided or presented.

Optionally, the knowledge test platform can provide or present the optional user feature to the security regulatory authority, and the security regulatory authority can customize a corresponding test question for a selected user feature.

Optionally, the knowledge test platform can provide or present an optional test question to the security regulatory authority, and the security regulatory authority can customize the corresponding user feature for a selected test question.

Optionally, the knowledge test platform can provide or present the optional user feature and the optional test question to the security regulatory authority, and the security regulatory authority can customize a mapping relationship between one or more selected user features and selected test questions.

In this embodiment, a specific requirement information configuration manner is not limited. For an associated security regulatory authority, the requirement information can be configured in one or more configuration manners. For example, customized requirement information and selected partial requirement information can be configured. Optionally, all requirement information configured for the security regulatory authority in one or more manners can be added to the security knowledge test requirement information set configured by the knowledge test platform for the security regulatory authority.

Therefore, optionally, the configuring a corresponding security knowledge test requirement information set for each of the one or more associated security regulatory authorities can include: obtaining customized requirement information from the associated security regulatory authority, and adding the customized requirement information to the security knowledge test requirement information set configured for the security regulatory authority; and/or providing or presenting predetermined requirement information to the associated security regulatory authority, so that the security regulatory authority make selection from the predetermined requirement information; obtaining selected specified requirement information from the security regulatory authority; and adding the specified requirement information to the security knowledge test requirement information set configured for the security regulatory authority.

In this embodiment, the knowledge test platform can provide or present a plurality of pieces of configuration requirement information to the security regulatory authority, to help configure the corresponding requirement information for the security regulatory authority based on a situation or requirement of the security regulatory authority, and improve experience of the security regulatory authority.

In an optional embodiment, the security knowledge test question can be a question related to security knowledge, and can be used to reflect whether the user has mastered related security knowledge. Whether the user has mastered the related security knowledge can be specifically reflected by whether an answer is correct. Therefore, the current security knowledge level of the user can be determined by using the test question.

A specific type of the test question is not limited in the procedure of the method. For example, the test questions can be multiple choice, fill in the blank, short answer, or interactive questions.

In a specific example, for a screenshot of a chat record between a merchant and a customer, chat content with risk can be tapped; or words describing different events can be dragged into different risk categories.

In an optional embodiment, a specific sender of the security knowledge test request is not limited. Provided that the security knowledge test request includes a feature of a certain user, which can be specifically an account identifier of the certain user, the security knowledge level test can be initiated for the user.

Certainly, optionally, a security knowledge test request sent by the target user can be received.

Optionally, a security knowledge test request sent by a user other than the target user can be received. The request includes the one or more features of the target user.

In this embodiment, a user can be conveniently invited to take a security knowledge level test. For example, for people who are not good at using a mobile phone, the people can be invited by another person to take a security knowledge level test, to improve user experience.

Certainly, a manner of inviting the user to take a test is not limited in this embodiment, and can be directly sending a security knowledge test request including a feature of an invited user, or can be a code scanning manner.

Optionally, the target user can initiate the security knowledge test request to the knowledge test platform by using a sharing code scanned by using a device. The security knowledge test request can be sent based on a scanning result of a sharing code provided or presented by another user.

A specific form of the sharing code is not limited in this embodiment, and can be a two-dimensional code or a barcode, provided that the sharing code can be scanned by using a device, to trigger an operation of sending the security knowledge test request to the knowledge test platform.

Optionally, another user who invites the user to take a test can view a security knowledge level test result of the invited user, to facilitate convenience for the user and improve user experience.

In a specific example, the people who are not good at using the mobile phone can be invited by a family member to take a security knowledge level test, and then the family member can view the security knowledge level test result, regulate whether the security knowledge level test is performed, and understand a specific security knowledge level, to facilitate education or science popularization.

In another specific example, a person responsible for popularizing the security knowledge test can invite another user to take a test, to achieve a popularization purpose, can view the security knowledge level test result, can learn of security knowledge levels of a plurality of users, and can further carry out more education or science popularization for users with a relatively low security knowledge level.

Therefore, optionally, the security knowledge test request can be sent based on the scanning result of the sharing code provided or presented by the another user. After determining the security knowledge level test result of the target user, the knowledge test platform can further synchronize the security knowledge level test result of the target user to the another user.

Optionally, the knowledge test platform can store a mapping relationship between an invited user and an inviting user, so that a plurality of subsequent security knowledge level test results of the invited user can be conveniently synchronized to the inviting user.

Optionally, for a first user who invites the target user to take a security knowledge test, an update of a subsequent security knowledge level test result of the target user, for example, invalid test result or a re-obtained test result, can be synchronously sent to the first user, so that the first user learns of the security knowledge level of the target user.

In a specific example, the user can share, by using a sharing code, a security knowledge test with an easily deceived old person or child, so that the user can learn of a security knowledge level of the old person or child in real time, and when the test result is invalid, can remind the old person or child to retake the test to determine and improve the security knowledge level, thereby strengthening prevention against a security risk and reducing the possibility of an infringement.

A method for determining the target security regulatory authority is not specifically limited in this embodiment.

In an optional embodiment, the target security regulatory authority can be specifically determined based on related information of the target user, or can be selected by the target user.

In a specific example, the security regulatory authority usually regulates a security risk of a user in a certain geographical region. For example, a security regulatory authority of a certain city usually needs to regulate a permanent residential population of the city and determine a security knowledge level; or can regulate a registered population of the city and determine the security knowledge level.

Therefore, a target security regulatory authority who needs to determine the security knowledge level of the target user usually needs to be determined based on a geographic location in which the target user is currently located or a geographical location of household registration to which the target user belongs.

In another specific example, for the target user, it may not be necessary to focus on which security regulatory authority's security knowledge level test to participate in. Instead, based on the requirements of a particular organization, it can be clear which security regulatory authorities need to participate.

For example, a company in which the target user is located needs to determine a security knowledge level of an employee, and designates a security regulatory authority in the headquarter of the company as the target security regulatory authority to perform a corresponding security knowledge level test.

Therefore, optionally, the target security regulatory authority can be determined based on geographical location information of the target user, or geographical location information of household registration, or selection of the target user. The target security regulatory authority can be specifically determined based on the received security knowledge test request.

Optionally, the security knowledge test request can include a current location of the target user; and the security regulatory authority can correspond to one location range, and perform the security knowledge level test for a user located within the corresponding location range.

Determining the target security regulatory authority based on the security knowledge test request can include: determining any security regulatory authority as the target security regulatory authority when it is determined that the current location of the target user in the security knowledge test request is within a corresponding location range of the any security regulatory authority.

Optionally, the security knowledge test request can include a household registration location of the target user; and the security regulatory authority can correspond to one location range, and perform the security knowledge level test for a user located within the corresponding location range.

Determining the target security regulatory authority based on the security knowledge test request can include: determining any security regulatory authority as the target security regulatory authority when it is determined that the household registration location of the target user in the security knowledge test request is within a corresponding location range of the any security regulatory authority.

Optionally, the security knowledge test request can include a security regulatory authority identifier specified by the target user.

Determining the target security regulatory authority based on the security knowledge test request can include: determining, as the target security regulatory authority, a security regulatory authority corresponding to the security regulatory authority identifier included in the security knowledge test request.

A specific method for determining the test question is not limited in the procedure of the method.

In an optional embodiment, the requirement information set corresponding to the target security regulatory authority can include a plurality of pieces of requirement information, and the requirement information includes the user feature.

Therefore, requirement information including a same feature can be determined in the requirement information set based on the one or more features of the target user in the security knowledge test request, and then a test question included in the requirement information can be determined.

In a specific example, the user feature can include an occupation, age, a type of a usually accessed network, etc. of the user.

The test question can be selected for the user in a customized manner based on the user feature, to perform the security knowledge level test, so that accuracy of the test result can be improved.

A source of feature data of the target user is not specifically limited in this embodiment. Optionally, when the target user grants authorization to allow the knowledge test platform to obtain the feature, the feature data can be obtained from a device of the target user or can be entered by the target user.

Optionally, when the corresponding test question is specifically determined, the one or more features of the target user in the security knowledge test request can be used, or the one or more features of the target user can be obtained from another data source other than the one or more features of the target user in the security knowledge test request.

For example, the knowledge test platform itself can be a feature provided by a payment application, which can obtain relevant characteristics of the target user in the payment application, specifically including the recipient of transfers, payment risk evaluation, transaction frequency, and so on.

Optionally, a quantity of determined test questions can be limited, to improve user experience. Specifically, a fixed limit can be set to determine a same quantity of test questions for each user; or a dynamic limit can be set to determine a corresponding quantity of test questions for a different user.

Optionally, a needed quantity of test questions can be determined based on the one or more features of the target user. For example, the quantity of test questions can be specifically determined based on the security knowledge level of the target user, a relatively large quantity of test questions can be determined for users with a relatively low security knowledge level, and a relatively small quantity of test questions can be determined for users with a relatively high security knowledge level.

In this embodiment, the test question can be determined for the user in a customized manner based on the user feature, to improve user experience, and improve accuracy of the test result in a targeted manner.

In an optional embodiment, the knowledge test platform can provide the determined test questions for the target user.

A specific manner of providing the test question is not limited in this embodiment. Optionally, the test question can be presented on a client device on which the target user initiates the security knowledge test request, so that the target user can answer the determined test question.

Optionally, the providing the test question for the target user can specifically include: sending the determined test question to the target user, so that the target user answers the received test question and completes the security knowledge level test, to help the knowledge test platform determine the security knowledge level test result of the target user.

A method for specifically determining the security knowledge level test result is not limited in this embodiment.

Optionally, an operation result of the target user for the determined test question can be obtained, or an answer of the target user to the determined test question can be directly obtained, and then the security knowledge level test result can be determined based on the operation result or the answer.

Optionally, a quantity or proportion of questions that are correctly answered by the target user to the determined test question can be determined based on the operation result or the answer.

Whether the target user has passed the security knowledge level test can be determined based on the quantity or proportion of correctly answered questions.

Optionally, when the quantity of questions that are correctly answered by the target user is greater than or equal to a predetermined quantity of questions, it can be determined that the target user has passed the security knowledge level test, to determine a test result representing that the test is passed.

When the quantity of questions that are correctly answered the target user is less than the predetermined quantity of questions, it can be determined that the target user fails the security knowledge level test, to determine a test result representing that the test is failed.

In a specific example, if the target user correctly answers all of the provided test questions, it can be determined that the target user passes the test; or if the target user does not correctly answer all of the provided test questions, it can be determined that the target user fails the test.

A form of the security knowledge level test result is not limited in this embodiment. Optionally, the form can represent that the security knowledge level test is passed or failed, or can represent the quantity or proportion of correctly answered questions in the security knowledge level test.

In an optional embodiment, a credential representing the test result can be further issued to the target user for the determined security knowledge level test result.

Because the test result can be used to determine the security knowledge level of the user, the credential representing the test result can be further generated to facilitate viewing by the another user.

For example, for the test result representing that the test is failed, the knowledge test platform can generate a red image, to represent that the test is failed; and for the test result representing that the test is passed, the knowledge test platform can generate a green image, to represent that the test is passed.

The generated credential can be issued to the device of the target user, so that the target user can present the credential to the another user for viewing, to conveniently determine the security knowledge level of the target user offline, and improve user experience.

Therefore, optionally, when the test result represents that the test is passed, a first credential can be issued to the target user. The first credential can be used to represent that the security knowledge level test of the target security regulatory authority is passed. The first credential is, for example, an anti-fraud green code.

Optionally, when the test result represents that the test is failed, a second credential can be issued to the target user. The second credential is used to represent that the security knowledge level test of the target security regulatory authority is failed. The second credential is, for example, an anti-fraud red code.

In an optional embodiment, a service with a specific security risk can be carried out offline based on the credential.

For example, when the user needs to transfer a large amount of money in a bank, the user can present the credential representing that the test is passed, to prove that the security knowledge level of the user is relatively high, to determine that the large amount of money can be transferred, and reduce the possibility that the user loses property due to a fraud or intimidation.

If the user cannot present the credential representing that the test is passed or a presented credential represents that the test is not passed, whether the large amount of money needs to be transferred can be determined in another manner. Specifically, a recipient of transfers, a transfer purpose, etc. can be determined.

Therefore, the credential representing the test result is generated, to reduce the possibility that the user is infringed by a risk.

In an optional embodiment, the credential can be generated based on the test result. A specific credential generation manner can be uniformly specified by the knowledge test platform.

For example, the knowledge test platform specifies the following credential generation manner. For the test result representing that the test is failed, a red image can be generated, to represent that the test is failed; and for the test result representing that the test is passed, a green image can be generated, to represent that the test is passed.

To reduce the possibility of forging the credential, optionally, information that can be used for verification can be added to the credential, for example, user identity information, test time information, or test location information.

In another optional embodiment, the security regulatory authority can further specify the credential generation manner. Specifically, the credential generation manner can include information based on which the credential is generated, whether encryption needs to be performed, etc.

In a specific example, a target credential generation method specified by the target security regulatory authority can include: encrypting user identifier information and the test result. Encryption/decryption needs to be performed by using a key specified by the target security regulatory authority, to reduce the possibility of disclosing user privacy and forging the credential. A two-dimensional code is further generated for an encryption result. However, if the test result represents that the test is passed, a green frame can be added outside the two-dimensional code; and if the test result represents that the test is failed, a red frame can be added outside the two-dimensional code.

A related person of the security regulatory authority can scan the two-dimensional code in the credential offline, decrypt the credential by using a designated key to obtain the user identifier information and the test result, and further query other information related to the user based on the user identifier information, to complete verification.

Optionally, the credential can include the target user's identifier information encrypted with the key designated by the target security regulatory authority, so that other user-related information can be queried based on the user identifier information contained in the credential. For example, the high-risk actions that the user has performed in the past, as well as the user's above-mentioned operations in the same scenario, can be easily accessed by the relevant personnel of the security regulatory authority based on the user information determined by the credential, to determine whether the user is allowed to perform risky actions.

Certainly, a specific credential generation manner is not limited in the procedure of the method, and the above-mentioned examples are only used for example description.

Therefore, optionally, a credential code that represents the test result can be issued to the target user. A scanning result of the credential code includes information about the target user.

Optionally, the credential code can intuitively present the test result by using a color, to be specific, whether the target user has passed the security knowledge level test.

A specific form of the credential code is not limited in this embodiment. The credential code can be a two-dimensional code or a barcode, provided that related information of the user can be obtained through scanning by using the device.

The information about the target user is not limited in this embodiment, and can be an identifier of the target user, or can be the one or more features of the target user or risk-related information, for example, a current security knowledge level of the target user, a high-risk action history, and a fraud history.

Optionally, the scanning result of the credential code can be encrypted, and needs to be decrypted by using the key provided by the target security regulatory authority, to improve security of the information about the target user.

In an optional embodiment, as a risk form is continuously updated, the security knowledge level of the user may gradually decrease. Therefore, a validity period can be set for the generated credential.

It is worthwhile to note that the test result represented by the credential can also have a validity period. When the credential is invalid, the test result can be invalid, and a test needs to be retaken.

When the credential is invalid, the user can obtain the credential again by retaking a test. Specifically, a user whose credential is invalid can be notified, so that the user learns, as soon as possible, that the credential is invalid.

Certainly, a validity period can be usually set for a credential representing that a test is passed, but no validity period can be set for a credential representing that a test is failed.

Therefore, optionally, a first credential used to represent that the test is passed can have a validity period. When it is determined that a current moment is outside the validity period of the first credential, a notification of expiration can be sent to the target user.

The notification of expiration can be used to remind the target user to retake the security knowledge level test.

In this embodiment, the validity period of the credential can be set, so that the user continuously takes the security knowledge level test, continuously improves the security knowledge level, and reduces the possibility of being endangered by a continuously updated risk form.

In an optional embodiment, as the risk form is continuously updated, the security knowledge is also continuously updated. Therefore, the knowledge test platform needs to update the requirement information set configured for the target security regulatory authority, to adapt to the continuously updated security knowledge, and improve the security knowledge level of the user.

For example, if a telecommunications fraud event occurs suddenly and frequently in a certain geographical region in which a security regulatory authority is located, the security regulatory authority can add a plurality of requirement information in terms of telecommunications fraud to a corresponding requirement information set.

As the target security regulatory authority updates the requirement information set, a user who has passed the test can correspondingly retake a test.

Updating the requirement information set may involve adding, deleting, or modifying the requirements information. From the perspective of user features in the requirement information set, if there is no updated requirement information corresponding to a certain user feature, it is not necessary to retest users with that characteristic. This can reduce the frequency of testing for users and improve the user experience

For the user feature included in the updated requirement information, because a corresponding test question changes, a user with the user feature usually needs to retake a test, to reduce a risk.

Therefore, optionally, the security regulatory authority can update the corresponding requirement information set.

When it is determined that any security regulatory authority updates a corresponding requirement information set, an update notification can be sent to a user satisfying a predetermined update condition. The update notification can be used to remind the user to retake the security knowledge level test.

The user satisfying the predetermined update condition can include: a user who passes the security knowledge level test of the security regulatory authority; and/or a user who satisfies a user feature in any updated requirement information in the user who passes the security knowledge level test of the security regulatory authority.

In this embodiment, the requirement information set of the security regulatory authority can be updated, so that the user continuously takes the security knowledge level test, continuously improves the security knowledge level, and reduces the possibility of being endangered by a continuously updated risk form.

In an optional embodiment, because the test result can reflect the security knowledge level of the user to some extent, the test result can be a feature of the user, and is used to perform a risk evaluation of another service.

Optionally, a risk control policy on any platform can be adjusted based on the test result, for example, a risk control policy of an application in which a knowledge test platform is located. The risk control policy can be used to evaluate a risk degree of a service to be performed by the user.

If the test result represents that the test is passed, the evaluated risk degree of the service to be performed by the user can be reduced; and if the test result represents that the test is passed, the evaluated risk degree of the service to be performed by the user can be increased.

Optionally, based on the test result representing that the test is passed, it is usually difficult to accurately determine that the security knowledge of the user is comprehensive enough, and even if the security knowledge is comprehensive enough, it is difficult to ensure that the user can bear a relatively large risk when actually executing the service.

However, for the test result representing that the test is failed, it can be determined that the security knowledge of the user is insufficient, to improve an evaluated risk degree and reduce the possibility that the user is infringed by a risk.

Therefore, optionally, when the test result represents that the test is failed, a risk control policy for the target user can be adjusted, to increase the risk degree evaluated for the target user.

In the procedure of the above-mentioned method, the security knowledge level test is performed online, to improve efficiency of determining a security knowledge level of the user, reduce labor costs, and accurately determine a current security knowledge level of the user based on the test result.

Customized security knowledge test requirement information can be further configured for the security regulatory authority by using the knowledge test platform, to satisfy actual requirements of different security regulatory authorities. The knowledge test platform can further help different security regulatory authorities to implement an online security knowledge level test without repeated development, to improve development efficiency.

A corresponding test question can be further determined based on the user feature, to adapt to an actual situation of the user, and improve accuracy of the security knowledge level test result.

In addition to the method embodiment, embodiments of this specification further provide corresponding apparatus embodiments.

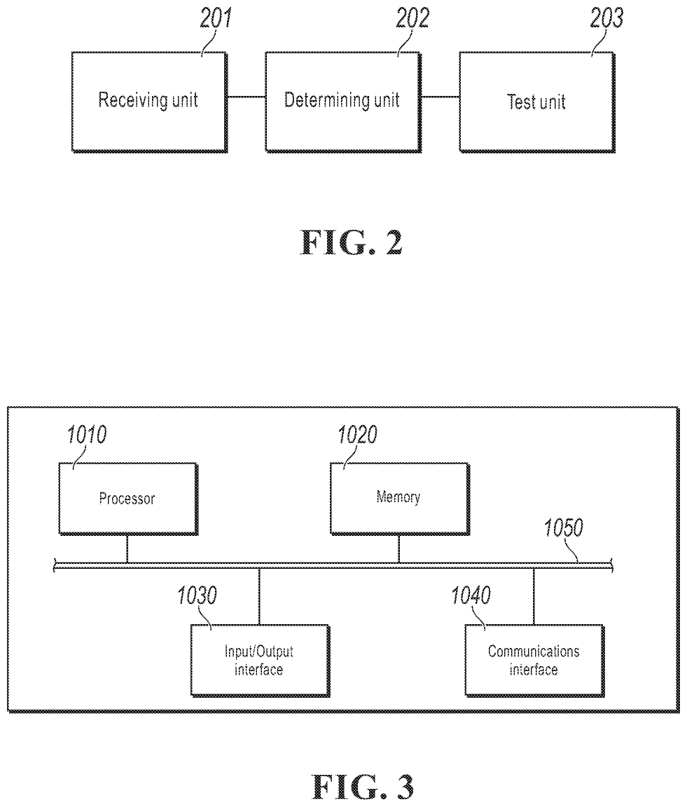

FIG. 2 is a schematic structural diagram illustrating a security knowledge level test apparatus, according to one or more embodiments of this specification. The apparatus can be applied to a knowledge test platform. The knowledge test platform can be associated with one or more security regulatory authorities, and pre-configures a corresponding security knowledge test requirement information set for each of the one or more associated security regulatory authorities, and the requirement information set can include a mapping relationship between one or more user features and security knowledge test questions.

The apparatus can include the following units:

A receiving unit 201 is configured to receive a security knowledge test request. The request can include one or more features of a target user.

A determining unit 202 is configured to: determine a target security regulatory authority based on the request, where the target security regulatory authority performs a security knowledge level test for the target user; and determine, from a requirement information set corresponding to the target security regulatory authority, corresponding test questions based on the one or more features of the target user.

A test unit 203 is configured to: provide the determined test questions for the target user, and determine a security knowledge level test result.

For a specific explanation of the apparatus embodiment, references can be made to the method embodiment. Details are omitted here.

Embodiments of this specification further provide a computer device, including at least a memory, a processor, and a computer program that is stored in the memory and can run on the processor. When the processor executes the program, any one of the method embodiments is implemented.

FIG. 3 is a schematic structural diagram illustrating a more specific hardware of a computer device, according to one or more embodiments of this specification. The device can include a processor 1010, a memory 1020, an input/output interface 1030, a communications interface 1040, and a bus 1050. The processor 1010, the memory 1020, the input/output interface 1030, and the communications interface 1040 are communicatively connected to each other within the device by using the bus 1050.

The processor 1010 can be implemented in a form of a general-purpose central processing unit (CPU), a microprocessor, an application-specific integrated circuit (ASIC), one or more integrated circuits, etc., and is configured to execute a related program, to implement the technical solutions provided in the embodiments of this specification.

The memory 1020 can be implemented in a form of a read-only memory (ROM), a random access memory (RAM), a static storage device, a dynamic storage device, etc. The memory 1020 can store an operating system and other application programs. When the technical solutions provided in the embodiments of this specification are implemented by software or firmware, related program code is stored in the memory 1020, and is invoked and executed by the processor 1010.

The input/output interface 1030 is configured to be connected to an input/output module, to implement information input and output. The input/output module can be configured as a component in the device (not shown in the figure), or can be externally connected to the device to provide a corresponding function. An input device can include a keyboard, a mouse, a touchscreen, a microphone, various sensors, etc., and an output device can include a display, a speaker, a vibrator, an indicator light, etc.

The communications interface 1040 is configured to be connected to a communications module (not shown in the figure), to implement communication and interaction between the device and another device. The communications module can implement communication through a wired method (for example, a USB or a network cable), or through a wireless method (for example, a mobile network, Wi-Fi, or Bluetooth).

The bus 1050 includes a path, to transmit information between components (for example, the processor 1010, the memory 1020, the input/output interface 1030, and the communications interface 1040) of the device.

It is worthwhile to note that, although only the processor 1010, the memory 1020, the input/output interface 1030, the communications interface 1040, and the bus 1050 are shown in the above-mentioned device, in a specific implementation process, the device can further include other components that are necessary for normal operation. In addition, a person skilled in the art can understand that, the above-mentioned device can include only the components that are necessary for implementing the solutions in the embodiments of this specification, and does not necessarily include all the components shown in the figure.

Embodiments of this specification further provide a computer-readable storage medium. The computer-readable storage medium stores a computer program, and when the program is executed by a processor, any one of the method embodiments is implemented.

The computer-readable medium includes persistent, non-persistent, movable, and unmovable media that can store information by using any method or technology. The information can be a computer-readable instruction, a data structure, a program module, or other data. Examples of a computer storage medium include but are not limited to: a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic cassette, a magnetic storage, another magnetic storage device, or any other non-transmission medium. The computer storage medium can be configured to store information that can be accessed by a computing device. As described in this specification, the computer-readable medium does not include a transitory computer-readable medium (transitory media) such as a modulated data signal and a carrier.

It can be seen from the above-mentioned descriptions of the implementations that, a person skilled in the art can clearly understand that the embodiments of this specification can be implemented by using software and a necessary general hardware platform. Based on such an understanding, the technical solutions in the embodiments of this specification essentially or the part contributing to the existing technology can be implemented in a form of a software product. The computer software product can be stored in a storage medium, for example, a ROM/RAM, a magnetic disk, or an optical disc, and includes some instructions for instructing a computer device (which can be a personal computer, a server, a network device, etc.) to perform the method described in the embodiments of this specification or in some parts of the embodiments of this specification.

The system, apparatus, module, or unit illustrated in the above-mentioned embodiments can be implemented by using a computer chip or an entity, or can be implemented by using a product having a certain function. A typical implementation device is a computer, and the computer can be a personal computer, a laptop computer, a cellular phone, a camera phone, a smartphone, a personal digital assistant, a media player, a navigation device, an email receiving and sending device, a game console, a tablet computer, a wearable device, or any combination of these devices.

The embodiments in this specification are described in a progressive way. For same or similar parts of the embodiments, references can be made to the embodiments mutually. Each embodiment focuses on a difference from other embodiments. In particular, the apparatus embodiments are basically similar to the method embodiments, and therefore are described briefly. For related parts, references can be made to related descriptions in the method embodiments. The previously described apparatus embodiments are merely examples. The modules described as separate parts may or may not be physically separate. During implementation of the solutions in the embodiments of this specification, functions of the modules can be implemented in one or more pieces of software and/or hardware. Some or all of the modules can be selected based on an actual need to implement the solutions of the embodiments. A person of ordinary skill in the art can understand and implement the embodiments without creative efforts.

The above-mentioned descriptions are merely specific implementations of the embodiments of this specification. It is worthwhile to note that a person of ordinary skill in the art can further make some improvements or polishing without departing from the principle of the embodiments of this specification, and the improvements or polishing shall fall within the protection scope of the embodiments of this specification.

What is claimed is:

1. A method performed by one or more computers, wherein the method comprises:
receiving a security knowledge test request that comprises one or more target features of a target user;
determining, based on the security knowledge test request and from a plurality of security regulatory authorities associated with a knowledge test platform, a target security regulatory authority to perform a security knowledge level test for the target user;
obtaining a target security knowledge test requirement information set that corresponds to the target security regulatory authority, wherein the target security knowledge test requirement information set comprises a mapping relationship between user features and security knowledge test questions;
determining, from the target security knowledge test requirement information set that corresponds to the target security regulatory authority, corresponding test questions based on the one or more target features of the target user;
providing the corresponding test questions for presentation on a client device to the target user; and
determining a security knowledge level test result from inputs to the client device by the target user in response to viewing the corresponding test questions.

2. The method of claim 1, further comprising:
issuing a first credential to the target user when the test result indicates that the target user has passed the security knowledge level test, wherein the first credential indicates that the target user has passed the security knowledge level test of the target security regulatory authority ; and
issuing a second credential to the target user when the test result indicates that the target user has not passed the security knowledge level test, wherein the second credential indicates that the target user has not passed the security knowledge level test of the target security regulatory authority.

3. The method of claim 2, wherein the first credential has a validity period, and the method further comprises:
sending a notification of expiration to the target user when a current time point is outside the validity period of the first credential, wherein the notification of expiration reminds the target user to retake the security knowledge level test.

4. The method of claim 1, wherein obtaining the target security knowledge test requirement information set that corresponds to the target security regulatory authorities comprises:
obtaining customized requirement information from the target security regulatory authority; and
adding the customized requirement information to the target security knowledge test requirement information set that corresponds to the target security regulatory authority.

5. The method of claim 1, wherein obtaining the target security knowledge test requirement information set that corresponds to the target security regulatory authorities comprises:
providing predetermined requirement information for the target security regulatory authority;
obtaining selected requirement information from the target security regulatory authority; and
adding the selected requirement information to the target security knowledge test requirement information set that corresponds to the target security regulatory authority.

6. The method of claim 1, wherein the security knowledge test request comprises a current location of the target user, the plurality of security regulatory authorities each corresponds to a respective location range and performs the security knowledge level test for users located within the respective location range, and wherein determining the target security regulatory authority:
determining a security regulatory authority as the target security regulatory authority when the current location of the target user is within a respective location range of the security regulatory authority.

7. The method of claim 1, wherein the target security regulatory authority updates the target security knowledge test requirement information set, and the method further comprises:
sending an update notification to a user who satisfies a predetermined update condition, wherein the update notification reminds the user to retake the security knowledge level test.

8. The method of claim 7, wherein the user who satisfies the predetermined update condition comprises one or both of:
a user who passes the security knowledge level test of the target security regulatory authority, or
a user of all users who have passed the security knowledge level test of the target security regulatory authority and satisfies a user feature included in the target security knowledge test requirement information that has been updated.

9. The method of claim 1, wherein the security knowledge test request is sent based on a scanning result of a sharing code provided by another user, and wherein the method further comprises:
synchronizing the security knowledge level test results of the target user to the another user.

10. The method of claim 1, further comprising:
issuing, to the target user, a credential code that represents the test result, wherein a scanning result of the credential code comprises information about the target user.

11. A non-transitory, computer-readable medium storing one or more instructions executable by a computer system to perform operations comprising:
receiving a security knowledge test request that comprises one or more target features of a target user;
determining, based on the security knowledge test request and from a plurality of security regulatory authorities associated with a knowledge test platform, a target security regulatory authority to perform a security knowledge level test for the target user;
obtaining a target security knowledge test requirement information set that corresponds to the target security regulatory authority, wherein the target security knowledge test requirement information set comprises a mapping relationship between user features and security knowledge test questions;
determining, from the target security knowledge test requirement information set that corresponds to the target security regulatory authority, corresponding test questions based on the one or more target features of the target user;
providing the corresponding test questions for presentation on a client device to the target user; and
determining a security knowledge level test result from inputs to the client device by the target user in response to viewing the corresponding test questions.

12. A system, comprising:
one or more computers; and
one or more computer memory devices interoperably coupled with the one or more computers and having tangible, non-transitory, machine-readable media storing one or more instructions that, when executed by the one or more computers, perform operations comprising:
receiving a security knowledge test request that comprises one or more target features of a target user;
determining, based on the security knowledge test request and from a plurality of security regulatory authorities associated with a knowledge test platform, a target security regulatory authority to perform a security knowledge level test for the target user;
obtaining a target security knowledge test requirement information set that corresponds to the target security regulatory authority, wherein the target security knowledge test requirement information set comprises a mapping relationship between user features and security knowledge test questions;
determining, from the target security knowledge test requirement information set that corresponds to the target security regulatory authority, corresponding test questions based on the one or more target features of the target user;
providing the corresponding test questions for presentation on a client device to the target user; and
determining a security knowledge level test result from inputs to the client device by the target user in response to viewing the corresponding test questions.

13. The system of claim 12, wherein the operations further comprise:
issuing a first credential to the target user when the test result indicates that the target user has passed the security knowledge level test, wherein the first credential indicates that the target user has passed the security knowledge level test of the target security regulatory authority ; and
issuing a second credential to the target user when the test result indicates that the target user has not passed the security knowledge level test, wherein the second credential indicates that the target user has not passed the security knowledge level test of the target security regulatory authority.

14. The system of claim 13, wherein the first credential has a validity period, and the method further comprises:
sending a notification of expiration to the target user when a current time point is outside the validity period of the first credential, wherein the notification of expiration reminds the target user to retake the security knowledge level test.

15. The system of claim 12, wherein obtaining the target security knowledge test requirement information set that corresponds to the target security regulatory authorities comprises:
obtaining customized requirement information from the target security regulatory authority; and
adding the customized requirement information to the target security knowledge test requirement information set that corresponds to the target security regulatory authority.

16. The system of claim 12, wherein obtaining the target security knowledge test requirement information set that corresponds to the target security regulatory authorities comprises:
providing predetermined requirement information for the target security regulatory authority;
obtaining selected requirement information from the target security regulatory authority; and
adding the selected requirement information to the target security knowledge test requirement information set that corresponds to the target security regulatory authority.

17. The system of claim 12, wherein the security knowledge test request comprises a current location of the target user, the plurality of security regulatory authorities each corresponds to a respective location range and performs the security knowledge level test for users located within the respective location range, and wherein determining the target security regulatory authority:
determining a security regulatory authority as the target security regulatory authority when the current location of the target user is within a respective location range of the security regulatory authority.

18. The system of claim 12, wherein the target security regulatory authority updates the target security knowledge test requirement information set, and the method further comprises:
sending an update notification to a user who satisfies a predetermined update condition, wherein the update notification reminds the user to retake the security knowledge level test.

19. The system of claim 18, wherein the user who satisfies the predetermined update condition comprises one or both of:
a user who passes the security knowledge level test of the target security regulatory authority, or
a user of all users who have passed the security knowledge level test of the target security regulatory authority and satisfies a user feature included in the target security knowledge test requirement information that has been updated.

20. The system of claim 12, wherein the security knowledge test request is sent based on a scanning result of a sharing code provided by another user, and wherein the method further comprises:
synchronizing the security knowledge level test results of the target user to the another user.
